(19) United States
(12) Patent Application Publication
(10) Pub. No.: US 2018/0274725 A1
(43) Pub. Date: Sep. 27, 2018

(54) HIGH-PRESSURE TANK HAVING STRUCTURE FOR RADIATION OF HEAT AND DISCHARGE OF REMAINING GAS AND METHOD OF MANUFACTURING THE SAME

(71) Applicants: HYUNDAI MOTOR COMPANY, Seoul (KR); KIA MOTORS CORPORATION, Seoul (KR); ILJIN COMPOSITE, Wanju-gun (KR)

(72) Inventors: Jae Han CHUNG, Incheon (KR); Jong Lyul KIM, Jeonju-si (KR); Gye Hyoung YOO, Jeonju-si (KR); Seok Bong HEO, Wanju-gun (KR)

(21) Appl. No.: 15/836,234

(22) Filed: Dec. 8, 2017

(30) Foreign Application Priority Data
Mar. 24, 2017 (KR) 10-2017-0037660

(51) Int. Cl. F17C 1/16; B29C 70/70

(52) U.S. Cl. CPC F17C 1/16; B29C 70/32; B29C 70/70

(57) ABSTRACT

A high-pressure includes a liner; a composite material surrounding an outer circumferential surface of the liner; a heat-transfer sheet formed on the outer circumferential surface of the liner; and a spacer disposed between the heat-transfer sheet and the composite material. The heat-transfer sheet and the spacer have a gap therebetween.

### CROSS-REFERENCE TO RELATED APPLICATION

This application claims under 35 U.S.C. § 119(a) the benefit of priority to Korean Patent Application No. 10-2017-0037660 filed on Mar. 24, 2017, the entire content of which is incorporated herein by reference.

### TECHNICAL FIELD

The present disclosure relates to a structure of a high-pressure tank, which stores high-pressure fuel in a fuel cell system, capable of outwardly discharging gas and of dissipating heat generated when the high-pressure fuel is charged.

### BACKGROUND

Generally, a fuel cell system includes a fuel cell stack for generating electricity, a fuel supply system for supplying fuel (hydrogen) to the fuel cell stack, an air supply system for supplying oxygen in air, which is an oxidant required for electrochemical reaction, to the fuel cell stack, and a heat and water management system for controlling the operating temperature of the fuel cell stack. The fuel supply system, i.e. a hydrogen supply system includes a high-pressure tank (hydrogen tank) in which compressed hydrogen having a high pressure of about 700 bar is stored. The stored compressed hydrogen is discharged to a high-pressure line according to an On/Off operation of a high pressure valve, which is mounted on the inlet portion of the hydrogen tank, and then undergoes depressurization while passing through a valve and a hydrogen supply valve to thereby be supplied to the fuel cell stack.

Considering the high-pressure tank of the above-described configuration in detail, the high-pressure tank is difficult to form in a size exceeding a given volume in order to be mounted in the fuel cell system, and thus there is a limit to the extent to which the inner volume of the tank may be increased. Hence, in order to increase the energy storage density, it may be necessary to increase the pressure with which gas is charged in the high-pressure tank. However, in order to charge gas at a high pressure, that is, in order for the high-pressure tank to have good storage capacity, the safety of the high-pressure tank needs to be ensured.

To this end, although there is a method of increasing the thickness of the wall, i.e. the cross section of the high-pressure tank, this method may cause deterioration in weight efficiency and a reduction in the inner volume of the high-pressure tank. Therefore, high-pressure tanks, which are manufactured using light-weight fiber-reinforced composite materials having a higher specific strength and specific stiffness than metal materials, are in the spotlight as a high-pressure tank that may be mounted in a vehicle fuel cell system.

In a configuration of the composite material high-pressure tank, a liner is located therein to maintain gas tightness and an outer shell thereof is reinforced (wound) with a fiber-reinforced composite material in order to cover the inner pressure of the high-pressure tank. The form of the high-pressure tank may be sorted according to the material of the liner and whether the liner is reinforced with the composite material. In vehicles, a so-called “type-3 liner” and “type-4 liner” are widely applied. However, the fiber-reinforced composite material may be applied to the entire liner regardless of the type of the liner.

The type-3 liner and the type-4 liner may be distinguished from each other according to the material of the liner. The type-3 liner may be formed of a metal material and the type-4 liner may be formed of a polymer material. The type-3 liner has higher gas safety than the type-4 liner, but is expensive and has poor fatigue resistance, whereas the type-4 liner is cheaper than the type-3 liner and has good fatigue-resistance, but exhibits poor gas anti-permeation performance.

In the type-4 liner described above, referring to FIGS. 1A, 1B and 2, in the state in which high-pressure gas is stored inside the liner, the gas may permeate the polymer liner to thereby be discharged to the outer surface of a high-pressure tank, which may lead to the mistaken perception that gas is leaking from the high-pressure tank. In addition, referring to FIG. 3, when the pressure inside the liner is lower than the pressure in the interface between the liner and a composite material, permeating gas (remaining gas), which has remained in the interface between the liner and the composite material, may cause inward buckling of the liner, thus causing deformation of the liner. Since this buckling may have an effect on the stability of the high-pressure tank and may also have an effect on the quality of products upon mass-production, in order to prevent such buckling, there exists a demand for the development of a technique that maximally prevents gas from remaining in the interface between the liner and the composite material.

### SUMMARY OF THE DISCLOSURE

In order to solve the problem described above, a method of employing a liner having high permeation resistance in order to prevent permeating gas (remaining gas) from remaining between the liner and a composite material, and a method of allowing remaining gas to be continuously and minutely discharged to the outside of a high-pressure tank may be considered. Hence, the disclosed technique suggests a remaining gas discharge structure, which guides permeating gas (remaining gas between a liner and a composite material) to be discharged outward only at a preset location through a given flow path, which is formed between the liner and the composite material, and a method of manufacturing the same.

In one aspect, the present disclosure provides a high-pressure tank including a liner, a composite material surrounding an outer circumferential surface of the liner, a heat-transfer sheet formed on the outer circumferential surface of the liner, and a spacer provided between the heat-transfer sheet and the composite material, wherein the heat-transfer sheet and the spacer have a gap therebetween.

The heat-transfer sheet may be formed of a metal material.

The spacer may have a circular cross section or a polygonal cross section having at least six angles.

The spacer may be thicker than the heat-transfer sheet.

The spacer may be narrower than the heat-transfer sheet.

The high-pressure tank may further include fixing rings configured to be inserted into opposite ends of the high-pressure tank, and ends of the spacer may go into the fixing rings.

The spacer may be formed of a material that is not adhered to a resin.

The heat-transfer sheet may include a center portion formed in a circumferential direction of the liner, and branch portions formed at equivalent intervals in a circumferential direction of the liner and coincidentally in parallel with an axial direction of the liner, and the center portion may be provided in a center of the liner, and the branch portions may extend from the center portion in opposite directions along the axial direction of the liner.

The spacer may include a center portion formed in a circumferential direction of the liner, and branch portions formed at equivalent intervals in a circumferential direction of the liner and coincidentally in parallel with an axial direction of the liner, and the center portion may be provided in a center of the liner, and the branch portions may extend from the center portion in opposite directions along the axial direction of the liner.

The center portion may have a loop on one end thereof so that opposite ends thereof are fastened to each other, or the center portion may have one end and an opposite end adhered to each other by a piece of adhesive tape, whereby the center portion and the branch portions closely contact with the outer circumferential surface of the liner.

In another aspect, the present disclosure provides a method of manufacturing a high-pressure tank including a liner and a composite material surrounding an outer circumferential surface of the liner, the method including closely contacting a heat-transfer sheet with the outer circumferential surface of the liner, and closely contacting a spacer with a top of the heat-transfer sheet.

The heat-transfer sheet may include a center portion, and branch portions formed at equivalent intervals in a circumferential direction of the liner and coincidentally in parallel with an axial direction of the liner, and, in the close contact of the heat-transfer sheet, the center portion may be located in a center of the liner, and opposite ends of the center portion may be fastened to each other, whereby the heat-transfer sheet closely contact with the outer circumferential surface of the liner.

The spacer may include a center portion, and branch portions formed at equivalent intervals in a circumferential direction of the liner and coincidentally in parallel with an axial direction of the liner, and the center portion and the branch portions of the spacer may be located to correspond to a center portion and branch portions of the heat-transfer sheet, whereby the spacer closely contact with the heat-transfer sheet.

The method may further include, after the close contact of the spacer, performing a release processing on a surface of the spacer, or fitting fixing rings to opposite ends of the liner, and the performing and the fitting may be performed in an arbitrary order.

The method may further include, after the performing and the fitting, performing a filament winding on an outer circumferential surface of the liner, the heat-transfer sheet, and the spacer.

In the performing the filament winding, a first layer of the filament winding may not be impregnated with resin.

In the performing the filament winding, the filament winding may include carbon fiber winding, and a first winding layer over the liner may be a helical layer formed by glass fiber winding.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A and 1B are views illustrating a state in which inner gas naturally permeates a liner and a composite material and a state in which gas leaks due to damage to the liner and/or the composite material for comparison therebetween;

FIG. 2 is a view illustrating a structure in which remaining gas is discharged from an interface between a liner and a composite material to a boss portion;

FIG. 3 is a view illustrating a state in which buckling occurs in a liner due to gas remaining between the liner and a composite material;

FIG. 4 is a view illustrating the cross section of a high-pressure tank in which a liner, a heat-transfer sheet, a spacer, and a composite material are stacked one above another according to an exemplary embodiment of the present disclosure;

FIGS. 5A and 5B are views illustrating embodiments of the heat-transfer sheet having a difference in the shape of the end of the center portion of the heat-transfer sheet;

FIGS. 6A and 6B are views illustrating embodiments of the spacer having a difference in the shape of the end of the center portion of the spacer;

FIG. 7 is a view illustrating fixing rings, which may be fitted to opposite ends of the high-pressure tank in order to integrate the liner with the spacer after the heat-transfer sheet is attached to the liner according to an embodiment of the present disclosure;

FIG. 8 is a view illustrating the structure of the high-pressure tank after the liner, the heat-transfer sheet, the spacer, and the fixing ring are fitted thereto according to an exemplary embodiment of the present disclosure; and

FIG. 9 is a view illustrating the sequence of manufacturing the high-pressure tank according to the present disclosure.

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, the exemplary embodiments of the present disclosure will be described in detail with reference to the accompanying drawings. The exemplary embodiments of the present disclosure may be modified in many different forms, and the scope of the present disclosure should not be construed as being limited to the following embodiments. These exemplary embodiments are provided so that this disclosure will be through and complete and will fully convey the scope to those skilled in the art.

In addition, for example, suffixes “portion”, “unit”, and “module” used herein mean an element that processes at least one function or operation, and may be realized by hardware or software, or by a combination of hardware and software.

A fuel cell system mounted in a vehicle may generally include, for example, a fuel cell stack for generating electricity, a fuel supply device for supplying fuel gas (hydrogen) to the fuel cell stack, an air supply device for supplying oxygen in air, which is an oxidant required for electrochemical reaction, to the fuel cell stack, a cooling system for removing reaction heat of the fuel cell stack to the outside of the system and controlling the operating temperature of the fuel cell stack, and a controller for adjusting the opening/closing of a plurality of valves provided in the fuel cell system.

In such a fuel cell system, considering the configuration of a high-pressure tank in which gas (hydrogen) is stored, the high-pressure tank may include a circular cylinder portion and dome portions, which may be formed in a dome shape on opposite sides of the cylinder portion. In addition, one dome portion may be provided with a nozzle, through which the inside of the high-pressure tank may be charged with gas and the gas may be discharged from the inside of the high-pressure tank. The nozzle may be formed of a metal material. The other dome portion may be kept airtight by, for example, an end plug.

Considering the gastightness performance of the high-pressure tank according to the types of a liner and a composite material constituting the high-pressure tank, in the case of a type-3 liner formed of a metal material, it is unlikely to form the interface in which gas may remain between the liner and the composite material because the composite material is made to physically compress the liner by autofrettage. However, in the case of a type-4 liner formed of a polymer material, although it may receive compressive force from the composite material, similar to the type-3, when the inside of the high-pressure tank is at a high pressure, since the degree of compaction of the composite material of the liner is small when the inside of the high-pressure tank is at a low pressure, a flow path, through which remaining gas may move, may be formed at the interface between the liner and the composite material or between fiber layers inside the composite material.

Therefore, the amount of remaining gas, which has permeated the liner and remains in the interface between the liner and the composite material, may be increased in the state in which the high-pressure tank is at a low pressure. The accumulated remaining gas may cause the misperception that a gas leak exists. In addition, when inner gas is completely exhausted within a short time for the servicing or inspection of the high-pressure tank, the remaining gas between the liner and the composite material may apply inward pressure to the liner. That is, the pressure of the remaining gas may become higher than the inner pressure of the high-pressure tank to thereby push the liner inward, causing a liner-buckling phenomenon.

That is, in the present disclosure, the phenomenon of gas permeating the liner may be distinguished from that of gas leaking from the liner. Specifically, gas permeation may be not a problem with the high-pressure tank, but may naturally occur in a polymer material due to the small molecular size of gas. On the other hand, gas leakage may be a problem with the high-pressure tank and may be caused by a defect of the high-pressure tank.

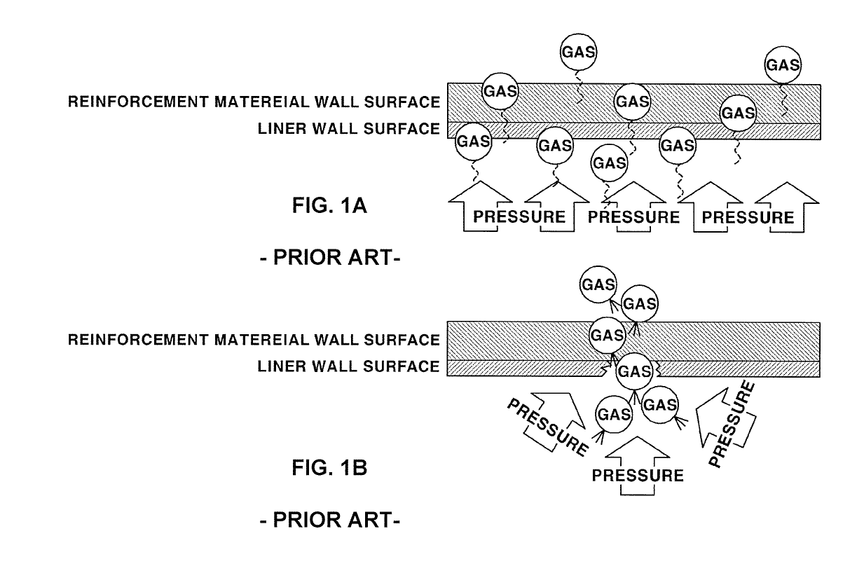

Considering the cross section of the cylinder portion and the dome portion in detail with reference to FIGS. 1A, 1B and 4, the high-pressure tank 10 may include a liner 20, which may form the inner circumferential surface of the high-pressure tank 10 and may be formed of, for example, a polymer material, and a reinforcement material such as a composite material 30 provided on the outer circumferential surface of the liner 20. Specifically, the composite material 30 may be wound around the outer circumferential surface of the liner 20. Such a technique of forming the high-pressure tank 10 by winding the composite material 30 around the outer circumferential surface of the liner 20 is typically known in the art and is clear to those skilled in the art, and thus a detailed description of the winding technique will be omitted below.

In addition, the high-pressure tank 10 may be charged with gas, more particularly, hydrogen, which may permeate a type-4 liner, i.e. the liner 20 formed of a plastic material because of the small molecular size thereof. Thereby, the gas that has permeated from the inside to the outside of the liner 20 may remain in the interface between the liner 20 and the reinforcement material, more particularly, the composite material 30, which surrounds the outer circumferential surface of the liner 20. In the present disclosure, the gas, which has permeated the liner 20 and remains between the liner 20 and the composite material 30, may be called “remaining gas”. That is, when the “permeating gas” that has passed through the liner 20 from the inside of the liner 20 remains in the interface between the liner 20 and the composite material 30, this gas may be referred to as “remaining gas”.

FIGS. 1A and 1B illustrate both a state in which the remaining gas naturally permeates the liner and the leakage state in which a large amount of gas leaks outward due to, for example, damage to or defects of the liner for comparison and distinguishing therebetween. That is, in the present disclosure, the state in which the remaining gas is discharged between the liner and the composite material may naturally occur over the entire inner circumferential surface of the liner, and needs to be distinguished from an abnormal case where one location of the liner or the composite material is damaged and pressure is concentrated on the corresponding location.

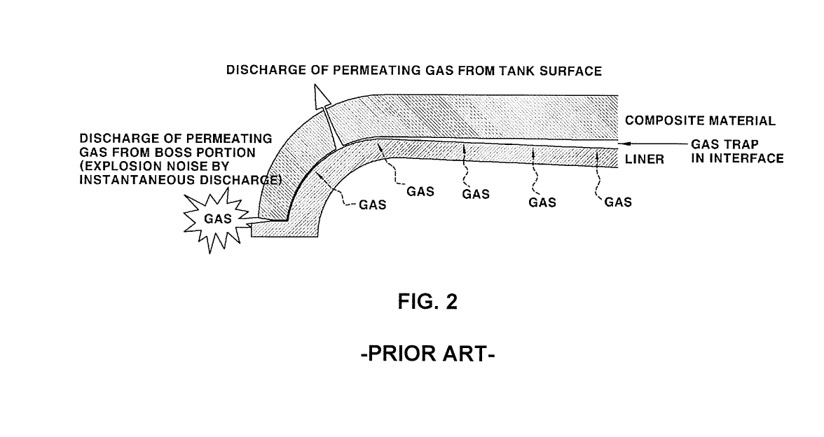

FIG. 2 illustrates the state of FIGS. 1A and 1B in detail, and illustrates the state in which the gas remains (is trapped) in the interface between the liner and the composite material. When the interface between the liner and the composite material is filled with gas, the remaining gas may not be discharged outward in real time. Thus, when the amount of remaining gas accumulated in the interface between the liner and the composite material exceeds a given amount, the gas may be discharged to the surface of the high-pressure tank 10, or may move to opposite ends of the high-pressure tank 10, at which a boss or an end plug may be present, along the interface between the liner and the composite material. As a result, the gas may be discharged at an unpredictable time from opposite ends of the high-pressure tank 10. In this case, for example, an explosion noise may be caused due to instantaneous discharge, which may be unpleasant for a user, or may create anxiety.

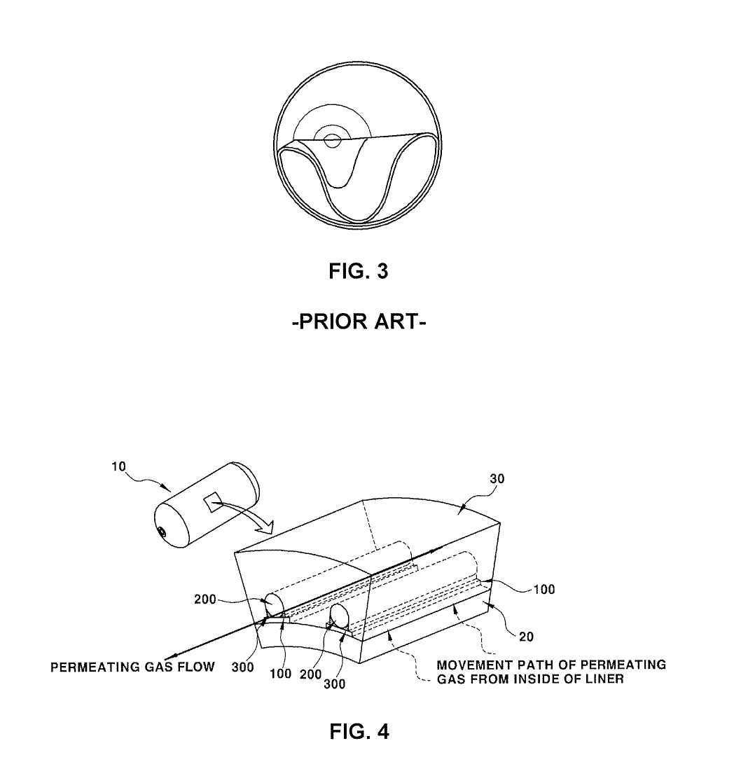

FIG. 3 illustrates the state in which the liner undergoes deformation such as buckling due to a pressure difference when pressure inside the liner of the high-pressure tank 10 is lower than the pressure of the remaining gas in the interface between the liner and the composite material. Specifically, a buckling phenomenon in which the remaining gas pushes the liner inward so as to separate the composite material and the liner from each other may occur. Therefore, the present disclosure is intended to suggest a structure capable of continuously exhausting an appropriate amount of remaining gas to the outside of the high-pressure tank 10 by artificially forming a flow path, through which the remaining gas may freely move, in the interface between the liner and the composite material, and a method of manufacturing the same.

FIG. 4 is a view illustrating the liner 20, the composite material 30, and the interface therebetween according to an embodiment of the present disclosure. In the present disclosure, the liner 20 and the composite material 30, which surrounds the outer circumferential surface of the liner 20, may be provided. In addition, a spacer 200 and a heat-transfer sheet 100 may be provided on the outer circumferential surface of the liner 20. Referring to FIG. 4, in the present disclosure, the heat-transfer sheet 100 may be formed on the outer circumferential surface of the liner 20 so as to come into close contact with the same, and the spacer 200 may be provided between the heat-transfer sheet 100 and the composite material 30. That is, the liner 20, the heat-transfer sheet 100, the spacer 200, and the composite material 30 may be stacked one above another in that sequence from the inside of the high-pressure tank 10.

In addition, a gap 300 may be formed in the contact surface of the spacer 200 and the heat-transfer sheet 100 due to the difference between the shapes of the spacer 200 and the heat-transfer sheet 100. The heat-transfer sheet 100 may take the form of a thin rectangular plate. The spacer 200 may have a circular cross-sectional shape or a cross-sectional shape corresponding to a polygonal shape having six or more sides. As such, when the spacer 200 is superimposed on the heat-transfer sheet 100, the gap 300 may be formed due to the difference between the shapes of the spacer 200 and the heat-transfer sheet 100, and the consequently formed gap 300 may serve as a flow path through which the remaining gas may be discharged. At this time, when the spacer 200 has a square or rectangular cross-sectional shape, the gap 300 may not be formed between the spacer 200 and the heat-transfer sheet 100 because the spacer 200 and the heat-transfer sheet 100 come into close contact with each other. Therefore, it is desirable to avoid such a spacer 200 having a square or rectangular cross-sectional shape.

The heat-transfer sheet 100 and the spacer 200 may be formed throughout the cylinder portion and the dome portions of the high-pressure tank 10, and the ends thereof may extend to opposite ends, i.e. the boss and/or the end plug of the high-pressure tank 10. However, it is noted that the shape or size of the gap 300 determined by the shape of the spacer 200 and the shape of the heat-transfer sheet 100 should not harm the structural integrity of the tank and should not cause deformation of the liner 20. In addition, it is noted that, when the composite material 30 is formed or wound, the gap 300 between the spacer 200 and the heat-transfer sheet 100 should not be clogged by, for example, a liquid-phase resin, which may be included in the layer of the composite material 30.

In other words, when the gap 300 is generated between the composite material 30 and the liner 20, the corresponding gap 300 may extend to opposite ends of the high-pressure tank 10. Thus, the inner pressure of the gap 300 may be similar to the atmospheric pressure. Meanwhile, since the composite material 30 and the liner 20 basically remain gastightness and may create a higher pressure than the atmospheric pressure, the gas permeating from the liner 20 may naturally gather in the gap 300 between the spacer 200 and the heat-transfer sheet 100 due to a pressure difference. The remaining gas gathered in the gap 300 between the spacer 200 and the heat-transfer sheet 100 may move along the gap 300, which extends to the ends of the high-pressure tank 10, and may then be naturally exhausted outward by a pressure difference. Accordingly, the gap 300 between the spacer 200 and the heat-transfer sheet 100 may function as a flow path for the discharge of the remaining gas.

As described above, according to the exemplary embodiment of the present disclosure, the heat-transfer sheet 100 may be configured as a thin metal plate, and may be formed using copper or aluminum, which has good thermal conductivity and excellent forming ability. It may be advantageous to minimize the thickness of the heat-transfer sheet 100 from the viewpoint of a reduction in the weight of the high-pressure tank 10. The heat-transfer sheet 100 may prevent the spacer 200 and the liner 20 from coming into contact with each other. In addition, the heat-transfer sheet 100 may have hardness and rigidity superior to those of the spacer 200, thereby serving as a support member for preventing the liner 20 from being damaged by the spacer 200. That is, the heat-transfer sheet 100 may serve to support the spacer 200 while guiding the position of the spacer 200.

In addition, the heat-transfer sheet 100 formed of a metal material may have excellent thermal conductivity. Thus, in the case where the high-pressure tank 10 is charged with high-pressure gas, the heat-transfer sheet 100 may perform a heat transfer function of uniformly distributing heat generated by adiabatic compression over the entire high-pressure tank 10, thereby preventing excessive heat generation at a location of the high-pressure tank 10. In addition, another effect acquired when the heat-transfer sheet 100 and the gap (flow path) 300 are formed parallel to each other is that the remaining gas may easily move to the ends of the high-pressure tank 10 through the gap 300 since the gas may exhibit better movement in the direction in which the heat-transfer sheet 100 is provided when the heat-transfer sheet 100 is heated.

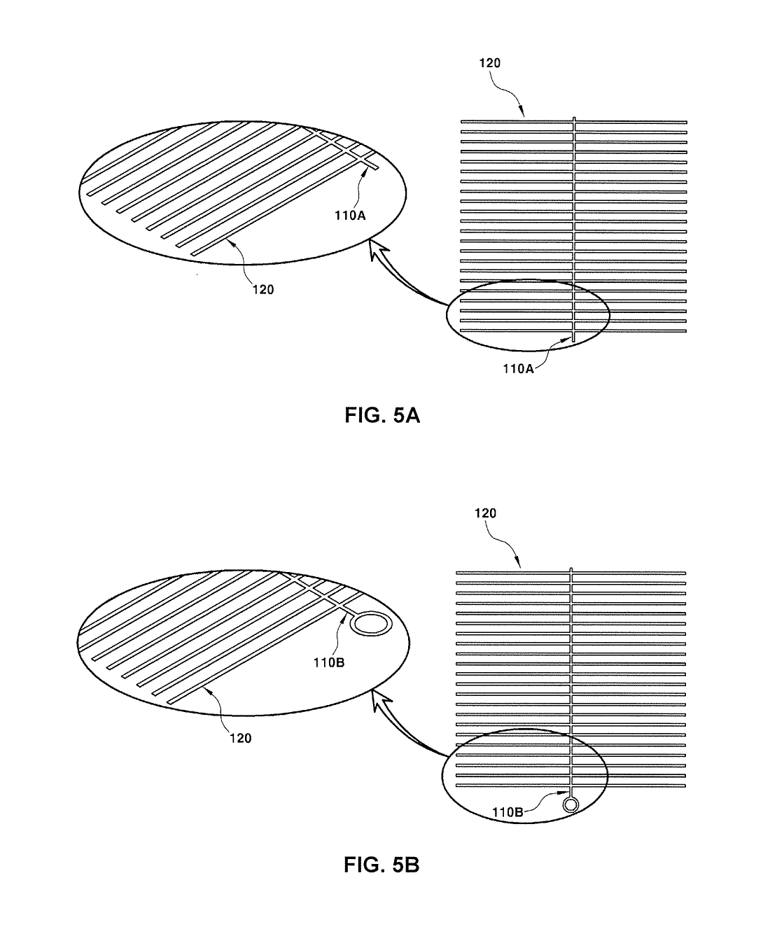

FIG. 5A is a view illustrating the heat-transfer sheet 100 according to one embodiment of the present disclosure. The heat-transfer sheet 100 may be centrally provided with a single line, which forms a center portion. The line that forms the center portion may be provided with branch portions. The branch portions may have a horizontally symmetrical shape. That is, the heat-transfer sheet 100 may include a center portion 110A and branch portions 120. A plurality of rectangular branch portions 120 may be arranged in the same number on opposite sides of the line that forms the center portion so as to extend perpendicular to the line. The center portion 110A, more particularly, the single line that forms the center portion 110A may be disposed in the center of the high-pressure tank 10, and may be wound in the circumferential direction of the liner 20. Thereby, the branch portions 120 may be aligned parallel to the axial direction of the liner 20. When the center portion 110A is wound in the circumferential direction of the liner 20, opposite ends of the center portion 110A may come into contact with each other. The ends of the center portion 110A may be fixed to each other by a piece of adhesive tape. In addition, FIG. 5B illustrates another embodiment of the present disclosure in which a loop 110B may be formed on one end of the center portion. In this case, the other end of the center portion may be fastened to the loop 110B. Specifically, the other end of the center portion may be fitted into the loop 110B formed on one end of the center portion, whereby the heat-transfer sheet 100 including the center portion and the branch portions 120 may come into close contact with the outer circumferential surface of the liner 20.

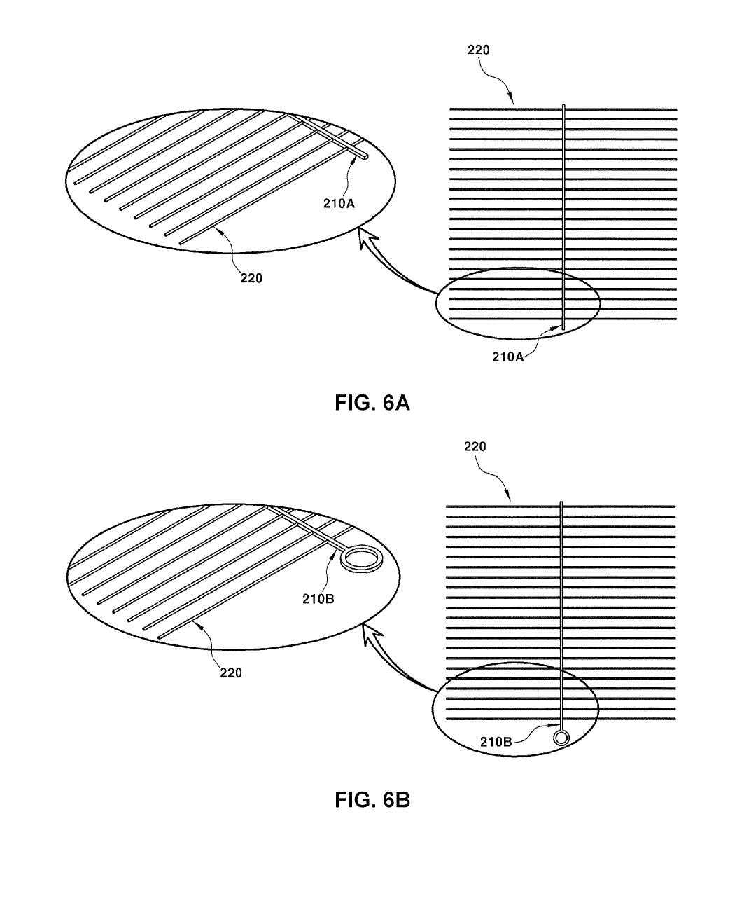

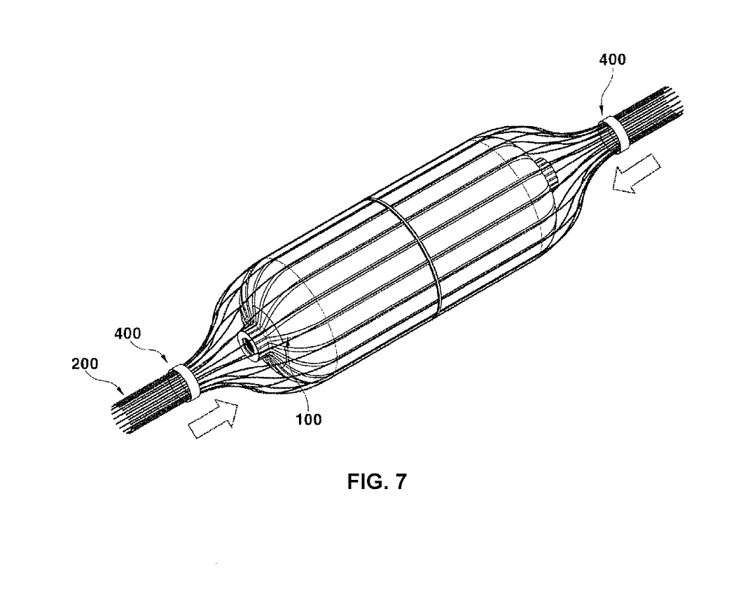

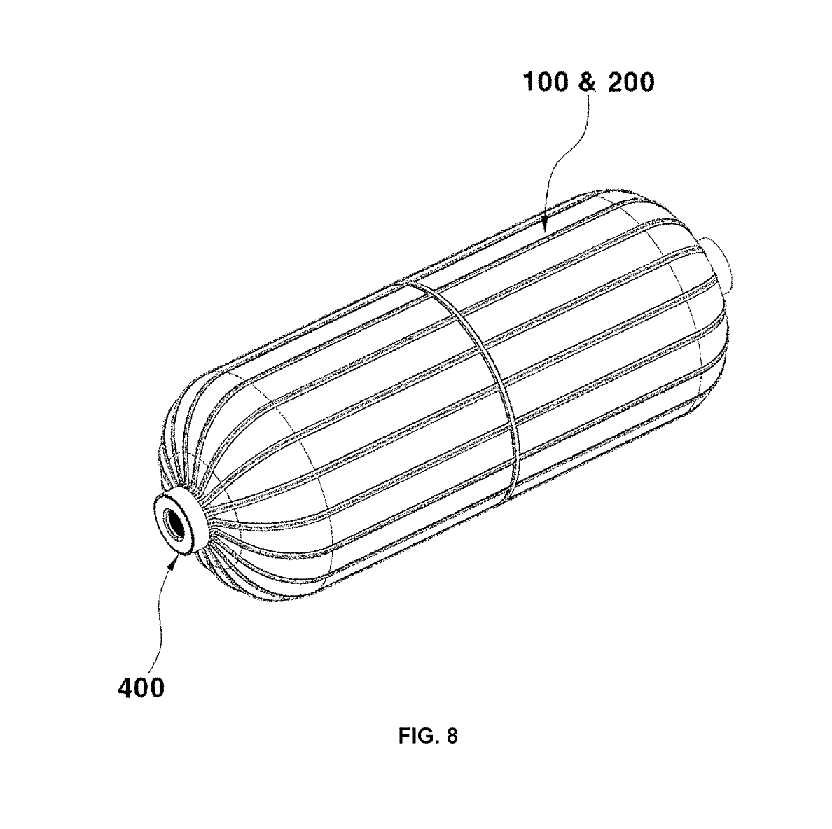

FIG. 6A is a view illustrating the spacer 200 according to one embodiment of the present disclosure. Since the spacer 200 may be provided over the heat-transfer sheet 100, the spacer 200 may have the same shape as the heat-transfer sheet 100. In the same manner as the heat-transfer sheet 100, the spacer 200 may include a center portion 210A and branch portions 220. Referring to FIG. 6A, the branch portions 220 may be formed about a line that forms the center portion 210A of the spacer 200. Specifically, the branch portions 220 may be horizontally symmetrically formed about the line that forms the center portion 210A. More specifically, a plurality of rectangular branch portions 220 of the spacer 200 may be arranged in the same number on opposite sides of the line that forms the center portion 210A of the spacer 200 so as to extend perpendicular to the line. The center portion 210A of the spacer 200, more particularly, the single line that forms the center portion 210A of the spacer 200 may be disposed over the center portion 110A of the heat-transfer sheet 100. Accordingly, in the same manner as the heat-transfer sheet 100, the center portion 210A of the spacer 200 may be wound in the circumferential direction of the liner 20. Thereby, the branch portions 220 of the spacer 200 may be aligned parallel to the axial direction of the liner 20. When the center portion 210A of the spacer 200 is wound in the circumferential direction of the liner 20, likewise, opposite ends of the center portion 210A may come into contact with each other. The ends of the center portion of the spacer 200 may be fixed to each other by a piece of adhesive tape. FIG. 6B illustrates another embodiment of the present disclosure in which a loop 210B may be formed on one end of the center portion of the spacer 200. In this case, the other end of the center portion may be fastened to the loop 210B of the spacer 200. Specifically, the other end of the center portion may be fitted into the loop 210B formed on one end of the center portion, whereby the spacer 200 including the center portion and the branch portions 220 may be superimposed on the heat-transfer sheet 100.

In addition, the branch portions 120 of the heat-transfer sheet 100 and the branch portions 220 of the spacer 200 may have lengths greater than at least the axial length of the outer circumferential surface of the high-pressure tank 10. In other words, the lengths of the branch portions 120 and 220 may be greater than the length of the outer circumferential surface of the high-pressure tank 10 that is measured in the axial direction of the high-pressure tank 10. That is, in the branch portions 120 and 220, which may be horizontally symmetrically formed about the center portion, the length of the branch portion on one side may be greater than at least half of the axial length of the outer circumferential surface of the high-pressure tank 10.

Meanwhile, the spacer 200 needs to have rigidity of a given level or more since it needs to maintain the shape thereof despite pressurization or compaction by the composite material 30, which may be superimposed over the spacer 200. However, when the rigidity and hardness of the spacer 200 are stronger than the rigidity and hardness of the liner 20, which may be formed inside the spacer 200, the spacer 200 may cause damage to the liner 20, more particularly, to the surface of the liner 20 by the force by which the composite material 30 presses the spacer 200. Therefore, the rigidity and hardness of the spacer 200 need to meet a given level, but need to be lower than the rigidity and hardness of the liner 20, which is formed of a plastic material.

In addition, the constituent material of the spacer 200 needs to have a low adhesive force for a resin, which may be included in the composite material 30. The spacer 200 may be formed of a material that has no adhesive force for a resin. Even if the gap (flow path) 300 between the spacer 200 and the heat-transfer sheet 100 is filled with a resin in the process of forming the high-pressure tank 10 by winding the composite material 30, this serves to enable the re-formation of the gap (flow path) 300 by allowing the spacer 200 to be separated from the resin upon receiving pressure, or via the rupture of the resin upon a performance test such as a hydrostatic test and/or a leakage test after the high-pressure tank 10 is formed. Accordingly, in an exemplary embodiment of the present disclosure, the composite material 30 may be formed of an epoxy resin, the liner 20 may be formed of a polyethylene (PE) or polyamide (PA) material, and the spacer 200 may be formed of a polyethylene (PE) material. Since the epoxy resin and the polyethylene material exhibit poor adhesion therebetween and the spacer 200 may have rigidity and hardness that are equal to or less than those of the liner 20, the aforementioned combination of materials may be optimal.

The spacer 200 may be thicker than the heat-transfer sheet 100. However, even in this case, it is noted that the spacer 200 should not be thick enough to weaken the structure of the high-pressure tank 10 or cause damage to the liner 20.

In addition, when the spacer 200 is wider than the heat-transfer sheet 100, even if the spacer 200 has a circular cross-sectional shape, no gap 300 may be formed between the heat-transfer sheet 100 and the spacer 200 when they come into close contact with each other. Therefore, since no flow path for the movement of the remaining gas may be formed, the width of the spacer 200 may be narrower than the width of the heat-transfer sheet 100.

FIG. 7 is a view illustrating the state in which fixing rings 400 are fitted to opposite ends of the spacer 200 after the heat-transfer sheet 100 comes into close contact with the outer circumferential surface of the liner 20 and the spacer 200 is superimposed on the heat-transfer sheet 100 according to an embodiment of the present disclosure. In the present disclosure, the length of the branch portions of the spacer 200 may be greater than the length of the high-pressure tank 10. In addition, after the spacer 200 is superimposed on the heat-transfer sheet 100, the fixing rings 400 may be provided on opposite ends of the high-pressure tank 10. Specifically, the spacer 200 may be inserted into the fixing ring 400, which may be provided on opposite ends of the high-pressure tank 10. The diameter of the fixing ring 400 may correspond to the diameter of the boss and/or the end plug of the high-pressure tank 10. The branch portions of the spacer 200 may first be brought into contact with the liner 20 along the cylinder portion of the high-pressure tank 10, and then may be gathered to the center of the end of the high-pressure tank 10 after entering the dome portion of the high-pressure tank 10. Thereby, the branch portions of the spacer 200 may be inserted into the fixing ring 400, which may be fitted to the center of the end of the high-pressure tank 10.

Hereinafter, a method of manufacturing the high-pressure tank 10 having a structure for radiation of heat and discharge of remaining gas will be described in detail. In the manufacture of the high-pressure tank 10 according to the embodiment of the present disclosure, the type-4 liner 20 may be manufactured using a method that is widely used in the field of the high-pressure tank 10 for a conventional fuel cell system, and thus a detailed description thereof will be omitted below.

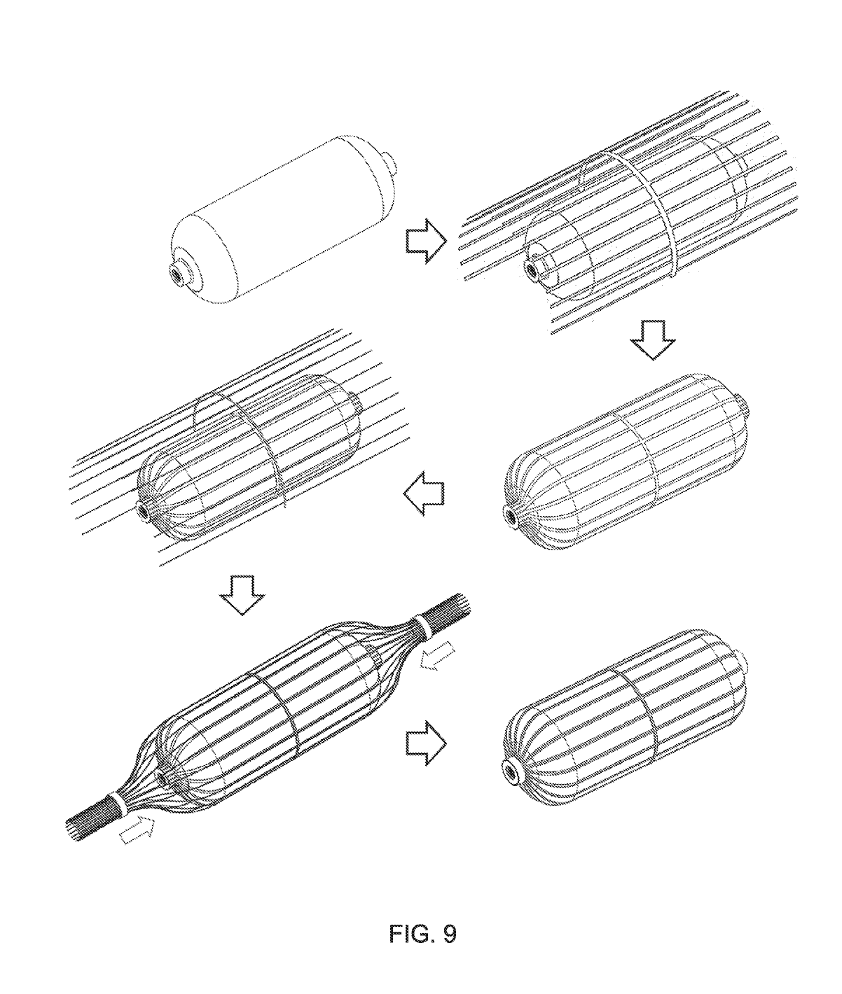

Referring to FIG. 9, the method of manufacturing the high-pressure tank 10 according to the embodiment of the present disclosure may include the step of closely contacting the heat-transfer sheet 100 with the outer circumferential surface of the liner 20. Specifically, one line formed on the center portion of the heat-transfer sheet 100 may be wound around the center of the cylinder portion of the liner 20 in the circumferential direction of the liner 20. Then, opposite ends of the center portion of the heat-transfer sheet 100 may be fastened to each other. Opposite ends of the center portion of the heat-transfer sheet 100 may be fixed to each other by a piece of adhesive tape, or one end of the center portion of the heat-transfer sheet 100 may be fitted into and fixed to the loop formed on the other end of the center portion. Thereby, the branch portions of the heat-transfer sheet 100 may be aligned along the axial direction of the liner 20, and specifically, may be equidistantly and circumferentially arranged on the outer circumferential surface of the liner 20 so as to be parallel to the axial direction of the liner 20.

Since the heat-transfer sheet 100, which may be formed of a metal material, easily maintains the shape thereof even without using an adhesive, the center portion and the branch portions of the heat-transfer sheet 100 may be aligned along the cylinder portion and the dome portion via, for example, manual operation. In particular, the heat-transfer sheet 100 formed of a metal material may be easily varied in shape despite the curved contour of the dome portion, and thus may be easily aligned along the outer circumferential surface of the liner 20.

After the heat-transfer sheet 100 comes into close contact with the outer circumferential surface of the liner 20, the method may include the step of closely contacting the spacer 200 with the heat-transfer sheet 100. Specifically, the step in which the spacer 200 is superimposed on the heat-transfer sheet 100 may be performed. The spacer 200 may be brought into close contact with the heat-transfer sheet 100 in the same manner as the manner in which the heat-transfer sheet 100 is brought into close contact with the liner 20. At this time, it may be important for the spacer 200 to be aligned so as to be superimposed on the heat-transfer sheet 100. In addition, when the spacer 200 is attached onto the heat-transfer sheet 100, for example, a release agent may be applied to the surface of the spacer 200 in advance for later smooth separation of the spacer 200. That is, after the release agent is applied to the spacer 200 in advance, the spacer 200 may be aligned so as to be superimposed on the heat-transfer sheet 100.

However, since the spacer 200 may be formed of a plastic material and may have elasticity, it may be difficult to fix the spacer 200 on the dome portion of the high-pressure tank 10, more particularly, the liner 20 so as to be superimposed on the heat-transfer sheet 100. Accordingly, after the center portion of the spacer 200 is superimposed on the center portion of the heat-transfer sheet 100 and the branch portions of the spacer 200 are superimposed on the branch portions of the heat-transfer sheet 100 on the cylinder portion of the liner 20, the step in which the fixing rings 400 are fitted to opposite ends of the high-pressure tank 10, more particularly, opposite ends of the liner 20 may be performed. Specifically, the step in which the branch portions of the spacer 200 are gathered and inserted into the fixing rings 400 and the step in which the fixing rings 400, into which the spacer 200 has been inserted, are fitted to opposite ends of the high-pressure tank 10 may be performed.

When the fixing rings 400 are fitted to opposite ends of the high-pressure tank 10, the spacer 200 may be fixed at a desired position. That is, the branch portions of the spacer 200 may remain superimposed on the branch portions of the heat-transfer sheet 100 on the dome portions by the fixing rings 400. Since the length of the branch portions of the heat-transfer sheet 100 and the branch portions of the spacer 200 is greater than the axial length of the liner 20, after the fixing rings 400 are fitted to opposite ends of the high-pressure tank 10, the extra length of the branch portions of the heat-transfer sheet 100 and the branch portions of the spacer 200 may be cut and removed.

After the heat-transfer sheet 100 is brought into close contact with the outer circumferential surface of the liner 20 and the spacer 200 is superimposed on the heat-transfer sheet 100, the step in which filaments are wound around the outer circumferential surface of the liner 20, i.e. the outer circumferential surface of the heat-transfer sheet 100 and the spacer 200 may be performed. At this time, since the surface to be wound by the heat-transfer sheet 100 and the spacer 200 is not flat, a first winding layer may be formed as a helical layer so as to be wound over the entire liner 20. However, the first winding layer may include no resin impregnated therein. In another embodiment of the present disclosure, when carbon fibers are wound, the first helical layer may include glass fibers for the sake of price reduction. When glass fibers are used, prior to winding the first layer, the outer circumferential surface of the liner 20 and the outer circumferential surface of the heat-transfer sheet 100 and the spacer 200 may be wrapped with a release film.

In an exemplary embodiment of the present disclosure, after winding of, for example, filaments, carbon fibers or glass fibers is completed, the degree of completion of the high-pressure tank 10 may be measured via a hydrostatic test and a leakage test. In the process of performing the hydrostatic test and the leakage test, resins hardened around the spacer 200 may be separated from the spacer 200, or may form cracks. Thereby, the gap 300 may naturally be formed between the spacer 200 and the resin, and may also be formed between the spacer 200 and the heat-transfer sheet 100. Through this process, consequently, the gap (flow path) 300 may be formed between the spacer 200 and the resin and between the spacer 200 and the heat-transfer sheet 100 in the axial direction of the high-pressure tank 10.

In summary, the key idea of the present disclosure is a structure in which the heat-transfer sheet and the spacer are provided between the liner and the composite material so that remaining gas may be continuously and naturally exhausted to the outside of the high-pressure tank through the gap (flow path) between the heat-transfer sheet and the spacer.

In addition, it is noted that the present disclosure has a feature that the heat-transfer sheet may serve as a support member between the spacer and the liner and may uniformly distribute heat, which is rapidly generated at a location of the high-pressure tank due to adiabatic compression of the high-pressure tank, over the entire high-pressure tank.

As is apparent from the above description, the present disclosure provides the following effects.

According to the present disclosure, gas that has permeated a liner may be continuously discharged outward, rather than remaining in the interface between the liner and a composite material. Accordingly, an unpredictable situation in which an excessive amount of gas remaining in the interface between the liner and the composite material is discharged all at once may be prevented.

In addition, according to the present disclosure, it is possible to prevent the instantaneous discharge of an excessive amount of remaining gas from being mistakenly presumed to be gas leakage, or to prevent damage to the liner due to gas that is not discharged outward.

In addition, according to the present disclosure, in the state in which the high-pressure tank is at a low pressure, it is possible to prevent the occurrence of buckling (damage) of the liner caused when the gas that has permeated the liner and remains between the liner and the composite material applies pressure to the liner.

In addition, according to the present disclosure, since a heat-transfer sheet may be formed along the outer circumferential surface of the liner, heat that may be generated inside the liner due to adiabatic compression when the high-pressure tank is charged with high-pressure gas may be uniformly and rapidly distributed to the entire high-pressure tank, which may suppress an increase in the temperature of the high-pressure tank.

The invention has been described in detail with reference to exemplary embodiments thereof. However, it will be appreciated by those skilled in the art that the present disclosure may be implemented in various modifications and alterations via, for example, addition, change or omission of constituent elements without departing from the principles and spirit of the invention, and these modifications and alterations are included in the scope of the present disclosure.

In addition, in the description of the embodiments of the present disclosure, a detailed description of known functions and configurations incorporated herein is omitted when it may make the subject matter of the present disclosure rather unclear. In addition, the terms used in the above description are defined in consideration of the functions in the embodiments of the present disclosure, and may be replaced by other terms based on intensions of users or operators, customs, or the like. Hence, the meanings of these terms should be based on the whole content of this specification. Accordingly, the above detailed description of the present disclosure is not intended to limit the present disclosure by the disclosed embodiments, and the accompanying claims should be construed as including other embodiments.

What is claimed is:

1. A high-pressure tank comprising:
a liner;
a composite material surrounding an outer circumferential surface of the liner;
a heat-transfer sheet disposed on the outer circumferential surface of the liner; and
a spacer disposed between the heat-transfer sheet and the composite material,
wherein the heat-transfer sheet and the spacer have a gap therebetween.

2. The high-pressure tank of claim 1, wherein the heat-transfer sheet is formed of a metal material.

3. The high-pressure tank of claim 1, wherein the spacer has a circular cross section or a polygonal cross section having at least six angles.

4. The high-pressure tank of claim 1, wherein the spacer has a thickness greater than a thickness of the heat-transfer sheet.

5. The high-pressure tank of claim 1, wherein the spacer has a width smaller than a width of the heat-transfer sheet.

6. The high-pressure tank of claim 1, further comprising fixing rings inserted into opposite ends of the high-pressure tank,
wherein one end of the spacer is disposed inside the fixing rings.

7. The high-pressure tank of claim 1, wherein the spacer is formed of a non-adhesive material to a resin.

8. The high-pressure tank of claim 1, wherein the heat-transfer sheet includes:
a center portion in a circumferential direction of the liner; and
branch portions spaced apart from each other at equivalent intervals in a circumferential direction of the liner and coincidentally in parallel with an axial direction of the liner, and
wherein the center portion is disposed in a center of the liner, and the branch portions extend in opposite directions from the center portion along the axial direction of the liner.

9. The high-pressure tank of claim 1, wherein the spacer includes:
a center portion in a circumferential direction of the liner; and
branch portions spaced apart from each other at equivalent intervals in a circumferential direction of the liner and coincidentally in parallel with an axial direction of the liner, and
wherein the center portion is disposed in a center of the liner, and the branch portions extend in opposite directions from the center portion along the axial direction of the liner.

10. The high-pressure tank of claim 8, wherein the center portion has a loop on one end thereof and another end of the center portion is fastened to the loop, such that the center portion and the branch portions closely contact with the outer circumferential surface of the liner.

11. The high-pressure tank of claim 8, wherein the one end and the other end of the center portion are adhered to each other such that the center portion and the branch portions closely contact with the outer circumferential surface of the liner.

12. A method of manufacturing a high-pressure tank, which includes
a liner and a composite material surrounding an outer circumferential surface of the liner, the method comprising:
closely contacting a heat-transfer sheet with the outer circumferential surface of the liner; and
closely contacting a spacer with a top of the heat-transfer sheet.

13. The method of claim 12, wherein the heat-transfer sheet includes:
a center portion; and
branch portions spaced apart at equivalent intervals in a circumferential direction of the liner and coincidentally in parallel with an axial direction of the liner, and
wherein, the center portion is located in a center of the liner in the close contact of the heat-transfer sheet, and opposite ends of the center portion are fastened to each other, whereby the heat-transfer sheet closely contacts with the outer circumferential surface of the liner.

14. The method of claim 12, wherein the spacer includes:
a center portion; and
branch portions spaced apart at equivalent intervals in a circumferential direction of the liner and coincidentally in parallel with an axial direction of the liner, and
wherein the center portion and the branch portions of the spacer are located to correspond to a center portion and branch portions of the heat-transfer sheet, whereby the spacer closely contacts with the heat-transfer sheet.

15. The method of claim 12, further comprising: after the close contact of the spacer,
performing a release processing on a surface of the spacer; or
fitting fixing rings to opposite ends of the liner,
wherein the performing and the fitting are performed in an arbitrary order.

16. The method of claim 15, further comprising: after the performing and the fitting, performing a filament winding on an outer circumferential surface of the liner, the heat-transfer sheet, and the spacer.

17. The method of claim 16, wherein, in the performing the filament winding, a first layer is separated from a resin.

18. The method of claim 16, wherein, in the performing the filament winding, the filament winding includes carbon fiber winding, and a first winding layer over the liner is a helical layer formed by glass fiber winding.
